(19) United States
(12) Patent Application Publication
(10) Pub. No.: US 2008/0248289 A1
(43) Pub. Date: Oct. 9, 2008

(54) Zinc Oxide Nanoparticles

(76) Inventors: Gerhard Jonschker, Spiessen-Elversberg (DE); Matthias Koch, Wiesbaden (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/997,260

(22) PCT Filed: Oct. 26, 2006
(86) PCT No.: PCT/EP2006/010328

§ 371 Date: Jan. 29, 2008

(30) Foreign Application Priority Data
Nov. 25, 2005 (DE) 10 2005 056 622.7

(51) Int. Cl. B32B 5/16; F21V 9/06; C08K 7/00

(52) U.S. Cl. 428/328; 428/404; 252/588; 252/589; 523/216

(57) ABSTRACT

The invention relates to zinc oxide nanoparticles having an average particle size in the range from 3 to 50 nm, dispersed in an organic solvent, according to one or more of claims 1 to 6, characterised in that in a step a) one or more precursors of the nanoparticles are converted into the nanoparticles in an alcohol, in a step b) the growth of the nanoparticles is terminated by addition of at least one modifier, which is a precursor of silica, when the absorption edge in the UV/VIS spectrum of the reaction solution has reached the desired value, in a step c) the silica coating is modified by addition of at least one further surface modifier selected from the group consisting of organofunctional silanes, quaternary ammonium compounds, phosphonates, phosphonium and sulfonium compounds or mixtures thereof, and optionally, in step d), the alcohol from step a) is removed and replaced by another organic solvent, to isolated nanoparticles, and to the use thereof for UV protection in polymers.

The invention relates to modified zinc oxide nanoparticles, to a process for the production of such particles, and to the use thereof for UV protection.

The incorporation of inorganic nanoparticles into a polymer matrix can influence not only the mechanical properties, such as, for example, impact strength, of the matrix, but also modifies its optical properties, such as, for example, wavelength-dependent transmission, colour (absorption spectrum) and refractive index. In mixtures for optical applications, the particle size plays an important role since the addition of a substance having a refractive index which differs from the refractive index of the matrix inevitably results in light scattering and ultimately in light opacity. The drop in the intensity of radiation of a defined wavelength on passing through a mixture shows a high dependence on the diameter of the inorganic particles.

In addition, a very large number of polymers are sensitive to UV radiation, meaning that the polymers have to be UV-stabilised for practical use. Many organic UV filters which would in principle be suitable here as stabilisers are unfortunately themselves not photostable or photocatalytically active, and consequently there continues to be a demand for suitable materials for long-term applications.

Suitable substances consequently have to absorb in the UV region, appear as transparent as possible in the visible region and be straightforward to incorporate into polymers. Although numerous metal oxides absorb UV light, they can, however, for the above-mentioned reasons only be incorporated with difficulty into polymers without impairing the mechanical or optical properties in the region of visible light.

The development of suitable nanomaterials for dispersion in polymers requires not only control of the particle size, but also of the surface properties of the particles. Simple mixing (for example by extrusion) of hydrophilic particles with a hydrophobic polymer matrix results in inhomogeneous distribution of the particles throughout the polymer and additionally in aggregation thereof. For homogeneous incorporation of inorganic particles into polymers, their surface must therefore be at least hydrophobically modified. In addition, the nanoparticulate materials, in particular, exhibit a great tendency to form agglomerates, which also survive subsequent surface treatment.

The literature contains various approaches to providing suitable particles:

International Patent Application WO 2005/070820 describes polymer-modified nanoparticles which are suitable as UV stabilisers in polymers. These particles can be obtained by a process in which in a step a) an inverse emulsion comprising one or more water-soluble precursors of the nanoparticles or a melt is prepared with the aid of a random copolymer of at least one monomer containing hydrophobic radicals and at least one monomer containing hydrophilic radicals, and in a step b) particles are produced. These particles are preferably ZnO particles having a particle size of 30 to 50 nm with a coating of a copolymer essentially consisting of lauryl methacrylate (LMA) and hydroxyethyl methacrylate (HEMA). The ZnO particles are produced, for example, by basic precipitation from an aqueous zinc acetate solution.

International Patent Application WO 2000/050503 describes a process for the preparation of zinc oxide gels by basic hydrolysis of at least one zinc compound in alcohol or an alcohol/water mixture, which is characterised in that the precipitate initially forming during the hydrolysis is allowed to mature until the zinc oxide has completely flocculated out, this precipitate is then compacted to give a gel and separated off from the supernatant phase.

International Patent Application WO 2005/037925 describes the production of ZnO and ZnS nanoparticles which are suitable for the preparation of luminescent plastics. The ZnO particles are precipitated from an ethanolic solution of zinc acetate by means of ethanolic NaOH solution and allowed to age for 24 hours before the ethanol is replaced by butanediol monoacrylate.

International Patent Application WO 2004/106237 describes a process for the production of zinc oxide particles in which a methanolic potassium hydroxide solution having a hydroxide ion concentration of 1 to 10 mol of OH per kg of solution is added to a methanolic solution of zinc carboxylic acid salts having a zinc ion concentration of 0.01 to 5 mol of Zn per kg of solution in a molar OH:Zn ratio of 1.5 to 1.8 with stirring, and the precipitation solution obtained when the addition is complete is matured at a temperature of 40 to 65° C. over a period of 5 to 50 min and subsequently cooled to a temperature of ≦25° C., giving particles which are virtually spherical.

The dissertation by K. Feddern (“Synthese und optische Eigenschaften von ZnO Nanokristallen” [Synthesis and Optical Properties of ZnO Nanocrystals], University of Hamburg, June 2002) describes the production of ZnO particles from zinc acetate by means of LiOH in isopropanol. The particles can be coated with SiO₂ here by the so-called “Stöber process” by reaction with tetraethoxysilane in the presence of ammonia, but cloudy dispersions form here. The coating of dispersed ZnO particles with orthophosphate or tributyl phosphate or diisooctyl-phosphinic acid is also described here.

In all these processes, however, precise setting of the absorption and scattering behaviour and control of the particle size are difficult or only possible to a limited extent.

It would therefore be desirable to have a process by means of which small zinc oxide nanoparticles can be formed directly by means of a suitable surface modification, wherever possible in an agglomerate-free manner, where the resultant particles in dispersions absorb radiation in the UV region, but hardly absorb or scatter any radiation in the visible region.

Surprisingly, it has now been found that this is possible if the particle formation is monitored and terminated at the desired time by addition of a modifier.

The present invention therefore relates firstly to zinc oxide nanoparticles having an average particle size, determined by particle correlation spectroscopy (PCS) or transmission electron microscope, in the range from 3 to 50 nm, whose particle surface has been modified by means of silica, dispersed in an organic solvent, characterised in that they are obtainable by a process in which in a step a) one or more precursors of the nanoparticles are converted into the nanoparticles in an alcohol, in a step b) the growth of the nanoparticles is terminated by addition of at least one modifier, which is a precursor of silica, when the absorption edge in the UV/VIS spectrum of the reaction solution has reached the desired value, and optionally, in step c) the alcohol from step a) is removed and replaced by another organic solvent.

The ZnO nanoparticles according to the invention which are present, dispersed by the process described, can also be isolated. This is achieved by removing the alcohol from step a) to dryness.

The present invention furthermore relates to a corresponding process for the production of zinc oxide nanoparticles having an average particle size, determined by particle correlation spectroscopy (PCS) or transmission electron microscope, in the range from 3 to 50 nm, dispersed in an organic solvent, characterised in that in a step a) one or more precursors of the nanoparticles are converted into the nanoparticles in an alcohol, in a step b) the growth of the nanoparticles is terminated by addition of at least one modifier, which is a precursor of silica, when the absorption edge in the UV/VIS spectrum of the reaction solution has reached the desired value, and optionally in step c) the alcohol from step a) is removed and replaced by another organic solvent.

Depending on the precursor employed, as described below, the salt forming during the ZnO formation is either filtered off in step b) or in step c).

The particles according to the invention are distinguished by high absorption in the UV region, particularly preferably in the UV-A region, together with high transparency in the visible region. In contrast to many zinc oxide grades known from the prior art, these properties of the particles according to the invention, dispersed in an organic solvent, do not change on storage or only do so to a negligible extent.

The particle size is determine, in particular, by particle correlation spectroscopy (PCS), where the investigation is carried out using a Malvern Zetasizer in accordance with the operating manual.

The diameter of the particles is determined here, as the d50 or d90 value.

The photocatalytic activity of untreated zinc oxide is reduced by application of the silica sheath.

For the purposes of the present invention, silica means a material essentially consisting of silicon dioxide and/or silicon hydroxide, where some of the Si atoms may also carry organic radicals which are already present in the modifiers.

In a preferred embodiment of the present invention, the photocatalytic activity of ZnO is reduced to such an extent that it is less than 0.20*10⁻³ mol/(kg*min) over one hour, preferably even less than 0.10*10⁻³ mol/(kg*min), determined by the oxidation of 2-propanol to acetone on irradiation with UV light from an Hg medium-pressure immersion lamp (for example Haereus model TQ718; 500 W), and particularly preferably can no longer be detected at all in the experiment. (Experimental conditions: 250 mg of ZnO particles suspended in 350 ml of 2-propanol at room temperature, oxygen bubbles through the dispersion during the irradiation).

The modifier, which is a precursor of silica, is preferably a trialkoxysilane or a tetraalkoxysilane, where alkoxy preferably stands for methoxy or ethoxy, particularly preferably for methoxy.

Particular preference is given in accordance with the invention to the use of tetramethoxysilane as modifier.

The modifier is added here, as described above, depending on the desired absorption edge, but generally 1 to 50 min after commencement of the reaction, preferably 10 to 40 min after commencement of the reaction and particularly preferably after about 30 min. The position of the absorption edge in the UV spectrum is dependent on the particle size in the initial phase of the zinc oxide particle growth. At the beginning of the reaction, it is at about 300 nm and shifts in the direction of 370 nm in the course of time. Addition of the modifier enables the growth to be interrupted at any desired point. A shift as close as possible to the visible region (from 400 nm) is desirable in order to achieve UV absorption over the broadest possible range. If the particles are allowed to grow too much, the solution becomes cloudy. The desired absorption edge is therefore in the range 300-400 nm, preferably in the range up to 320-380 nm. Optimum values have proven to be between 355 and 365 nm.

At the same time, the nanoparticles are successfully isolated in accordance with the invention from the dispersions in a virtually agglomerate-free manner by further modification by means of a surface modifier, since the individual particles form directly coated.

In addition, the nanoparticles obtainable using this method can be redispersed particularly simply and uniformly, where, in particular, undesired impairment of the transparency of such dispersions in visible light can be substantially avoided.

In a variant of the invention, the invention therefore relates to zinc oxide nanoparticles having an average particle size, determined by particle correlation spectroscopy (PCS), in the range from 3 to 50 nm, whose particle surface has been modified by means of silica, dispersed in an organic solvent, characterised in that they are obtainable by a process in which in a step a) one or more precursors of the nanoparticles are converted into the nanoparticles in an alcohol, in a step b) the growth of the nanoparticles is terminated by addition of at least one modifier, which is a precursor of silica, when the absorption edge in the UV/VIS spectrum of the reaction solution has reached the desired value, in a step c) the silica coating is modified by addition of at least one further surface modifier selected from the group consisting of organofunctional silanes, quaternary ammonium compounds, phosphonates, phosphonium and sulfonium compounds or mixtures thereof, and optionally, in step d), the alcohol from step a) is removed and replaced by another organic solvent.

The nanoparticles produced in this way are isolated in step d) by removing the alcohol from step a) to dryness. Any salt load forming can be removed by filtration both in step b), c) and also in step d).

Suitable surface modifiers are, for example, organofunctional silanes, quaternary ammonium compounds, phosphonates, phosphonium and sulfonium compounds or mixtures thereof. The surface modifiers are preferably selected from the group of the organofunctional silanes.

The surface modifier requirements described are, in accordance with the invention, satisfied, in particular, by an adhesion promoter which carries two or more functional groups. A group of the adhesion promoter reacts chemically with the oxide surface of the nanoparticle. Alkoxysilyl groups (for example methoxy- and ethoxysilanes), halosilanes (for example chlorosilanes) or acidic groups of phosphoric acid esters or phosphonic acids and phosphonic acid esters come into consideration here. The groups described are linked to a second functional group via a relatively long spacer. This spacer is a nonreactive alkyl chain, siloxane, polyether, thioether or urethane or a combination of these groups of the general formula (C,Si)ₙHₘ(N,O,S)ₓ, where n=1-50, m=2-100 and x=0-50. The functional group is preferably an acrylate, methacrylate, vinyl, amino, cyano, isocyanate, epoxide, carboxyl or hydroxyl group.

Silane-based surface modifiers are described, for example, in DE 40 11 044 C2. Phosphoric acid-based surface modifiers are obtainable, inter alia, as Lubrizol® 2061 and 2063 from LUBRIZOL (Langer & Co.). Suitable silanes are, for example, vinyltrimethoxysilane, aminopropyltriethoxysilane, N-ethylamino-N-propyldimethoxysilane, iso-cyanatopropyltriethoxysilane, mercaptopropyltrimethoxysilane, vinyltriethoxysilane, vinylethyldichlorosilane, vinylmethyldiacetoxysilane, vinyl-methyldichlorosilane, vinylmethyldiethoxysilane, vinyltriacetoxysilane, vinyltrichlorosilane, phenylvinyidiethoxysilane, phenylallyldichlorosilane, 3-isocyanatopropoxytriethoxysilane, methacryloxypropenyltrimethoxy-silane, 3-methacryloxypropyltrimethoxysilane, 3-glycidyloxypropyltri-methoxysilane, 1,2-epoxy-4-(ethyltriethoxysilyl)cyclohexane, 3-acryloxypropyltrimethoxysilane, 2-methacryloxyethyltrimethoxysilane, 2-acryloxy-ethyltrimethoxysilane, 3-methacryloxypropyltriethoxysilane, 3-acryloxypropyltrimethoxysilane, 2-methacryloxyethyltriethoxysilane, 2-acryloxy-ethyltriethoxysilane, 3-methacryloxypropyltris(methoxyethoxy)silane, 3-methacryloxypropyltris(butoxyethoxy)silane, 3-methacryloxypropyltris(propoxy)silane, 3-methacryloxypropyltris(butoxy)silane, 3-acryloxy-propyltris(methoxyethoxy)silane, 3-acryloxypropyltris(butoxyethoxy)silane, 3-acryloxypropyltris(propoxy)silane, 3-acryloxypropyltris(butoxy)silane, 3-Methacryloxypropyltrimethoxysilane is particularly preferred. These and other silanes are commercially available, for example, from ABCR GmbH & Co., Karlsruhe, or from Sivento Chemie GmbH, Düsseldorf.

Vinylphosphonic acid and diethyl vinylphosphonate may also be mentioned here as adhesion promoters (manufacturer: Hoechst AG, Frankfurt am Main).

It is particularly preferred in accordance with the invention for the surface modifier to be an amphiphilic silane of the general formula (R)₃Si—S_{P}-Aₕₚ-B_{hb}, where the radicals R may be identical or different and represent hydrolytically removable radicals, S_{P} denotes either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms, Aₕₚ denotes a hydrophilic block, B_{hb} denotes a hydrophobic block, and where at least one reactive functional group is preferably bonded to Aₕₚ and/or B_{hb}.

The amphiphilic silanes contain a head group (R)₃Si, where the radicals R may be identical or different and represent hydrolytically removable radicals. The radicals R are preferably identical.

Suitable hydrolytically removable radicals are, for example, alkoxy groups having 1 to 10 C atoms, preferably having 1 to 6 C atoms, halogens, hydrogen, acyloxy groups having 2 to 10 C atoms and in particular having 2 to 6 C atoms or NR′₂ groups, where the radicals R′ may be identical or different and are selected from hydrogen and alkyl having 1 to 10 C atoms, in particular having 1 to 6 C atoms. Suitable alkoxy groups are, for example, methoxy, ethoxy, propoxy or butoxy groups. Suitable halogens are, in particular, Br and Cl. Examples of acyloxy groups are acetoxy and propoxy groups. Oximes are furthermore also suitable as hydrolytically removable radicals. The oximes here may be substituted by hydrogen or any desired organic radicals. The radicals R are preferably alkoxy groups and in particular methoxy or ethoxy groups.

A spacer S_{P} is covalently bonded to the above-mentioned head group and functions as connecting element between the Si head group and the hydrophilic block Aₕₚ and takes on a bridge function for the purposes of the present invention. The group S_{P} is either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms.

The C₁-C₁₈-alkyl group of S_{P} is, for example, a methyl, ethyl, isopropyl, propyl, butyl, sec-butyl or tert-butyl, furthermore also pentyl, 1-, 2- or 3-methylbutyl, 1,1-, 1,2- or 2,2-dimethylpropyl, 1-ethylpropyl, hexyl, heptyl, octyl, nonyl, decyl, undecyl, dodecyl, tridecyl or tetradecyl group. It may optionally be perfluorinated, for example as difluoromethyl, tetrafluoroethyl, hexafluoropropyl or octafluorobutyl group.

A straight-chain or branched alkenyl having 2 to 18 C atoms, in which a plurality of double bonds may also be present, is, for example, vinyl, allyl, 2- or 3-butenyl, isobutenyl, sec-butenyl, furthermore 4-pentenyl, isopentenyl, hexenyl, heptenyl, octenyl, —C₉H₁₆, —C₁₀H₁₈ to —C₁₈H₃₄, preferably allyl, 2- or 3-butenyl, isobutenyl, sec-butenyl, furthermore preferably 4-pentenyl, isopentenyl or hexenyl.

A straight-chain or branched alkynyl having 2 to 18 C atoms, in which a plurality of triple bonds may also be present, is, for example, ethynyl, 1- or 2-propynyl, 2- or 3-butynyl, furthermore 4-pentynyl, 3-pentynyl, hexynyl, heptynyl, octynyl, —C₉H₁₄, —C₁₀H₁₆ to —C₁₈H₃₂, preferably ethynyl, 1- or 2-propynyl, 2- or 3-butynyl, 4-pentynyl, 3-pentynyl or hexynyl.

Unsubstituted saturated or partially or fully unsaturated cycloalkyl groups having 3-7 C atoms can be cyclopropyl, cyclobutyl, cyclopentyl, cyclohexyl, cycloheptyl, cyclopentenyl, cyclopenta-1,3-dienyl, cyclohexenyl, cyclohexa-1,3-dienyl, cyclohexa-1,4-dienyl, phenyl, cycloheptenyl, cyclohepta-1,3-dienyl, cyclohepta-1,4-dienyl or cyclohepta-1,5-dienyl groups, which are substituted by C₁- to C₆-alkyl groups.

The spacer group S_{P} is followed by the hydrophilic block Aₕₚ. The latter can be selected from nonionic, cationic, anionic and zwitterionic hydrophilic polymers, oligomers and groups. In the simplest embodiment, the hydrophilic block comprises ammonium, sulfonium or phosphonium groups, alkyl chains containing carboxyl, sulfate or phosphate side groups, which may also be in the form of a corresponding salt, partially esterified anhydrides containing a free acid or salt group, OH-substituted alkyl or cycloalkyl chains (for example sugars) containing at least one OH group, NH— and SH-substituted alkyl or cycloalkyl chains or mono-, di-, tri- or oligoethylene glycol groups. The length of the corresponding alkyl chains can be 1 to 20 C atoms, preferably 1 to 6 C atoms.

The nonionic, cationic, anionic or zwitterionic hydrophilic polymers, oligomers or groups here can be prepared from corresponding monomers by polymerisation by the methods which are generally known to the person skilled in the art. Suitable hydrophilic monomers here contain at least one dispersing functional group selected from the group consisting of
(i) functional groups which can be converted into anions by neutralisers, and anionic groups, and/or
(ii) functional groups which can be converted into cations by neutralisers and/or quaternising agents, and cationic groups, and/or
(iii) nonionic hydrophilic groups.

The functional groups (i) are preferably selected from the group consisting of carboxyl, sulfonyl and phosphonyl groups, acidic sulfuric acid and phosphoric acid ester groups and carboxylate, sulfonate, phosphonate, sulfate ester and phosphate ester groups, the functional groups (ii) are preferably selected from the group consisting of primary, secondary and tertiary amino groups, primary, secondary, tertiary and quaternary ammonium groups, quaternary phosphonium groups and tertiary sulfonium groups, and the functional groups (iii) are preferably selected from the group consisting of omega-hydroxy- and omega-alkoxypoly(alkylene oxide)-1-yl groups.

If not neutralised, the primary and secondary amino groups can also serve as isocyanate-reactive functional groups.

Examples of highly suitable hydrophilic monomers containing functional groups (i) are acrylic acid, methacrylic acid, beta-carboxyethyl acrylate, ethacrylic acid, crotonic acid, maleic acid, fumaric acid and itaconic acid; olefinically unsaturated sulfonic and phosphonic acids and partial esters thereof; and mono(meth)acryloyloxyethyl maleate, mono(meth)acryloyloxyethyl succinate and mono(meth)acryloyloxyethyl phthalate, in particular acrylic acid and methacrylic acid.

Examples of highly suitable hydrophilic monomers containing functional groups (ii) are 2-aminoethyl acrylate and methacrylate and allylamine.

Examples of highly suitable hydrophilic monomers containing functional groups (iii) are omega-hydroxy- and omega-methoxypoly(ethylene oxide)-1-yl, omega-methoxypoly(propylene oxide)-1-yl and omega-methoxypoly(ethylene oxide-co-polypropylene oxide)-1-yl acrylate and methacrylate, and hydroxyl-substituted ethylenes, acrylates and methacrylates, such as, for example, hydroxyethyl methacrylate.

Examples of suitable monomers for the formation of zwitterionic hydrophilic polymers are those in which a betaine structure occurs in the side chain. The side group is preferably selected from —(CH₂)ₘ—(N⁺(CH₃)₂)—(CH₂)ₙ—SO₃⁻, —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃₂— and —(CH₂)ₘ—(P⁺(CH₃)₂)—(CH₂)ₙ—SO₃⁻, where m stands for an integer from the range 1 to 30, preferably from the range 1 to 6, particularly preferably 2, and n stands for an integer from the range 1 to 30, preferably from the range 1 to 8, particularly preferably 3.

It may be particularly preferred here for at least one structural unit of the hydrophilic block to contain a phosphonium or sulfonium radical.

Corresponding structures can generally be produced in accordance with the following scheme:

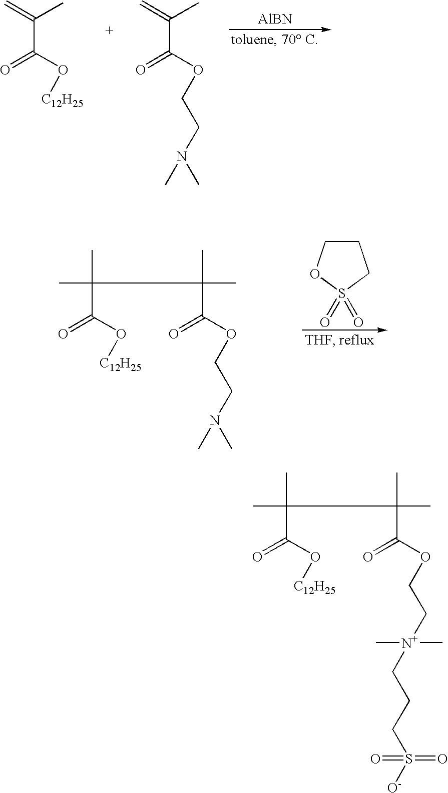

Here, the desired amounts of lauryl methacrylate (LMA) and dimethylaminoethyl methacrylate (DMAEMA) are copolymerised by known methods, preferably by means of free radicals in toluene by addition of AIBN. A betaine structure is subsequently obtained by reaction of the amine with 1,3-propane sultone by known methods.

In another variant of the invention, it is preferred to employ a copolymer essentially consisting of lauryl methacrylate (LMA) and hydroxyethyl methacrylate (HEMA), which can be prepared in a known manner by free-radical polymerisation using AIBN in toluene.

When selecting the hydrophilic monomers, it should be ensured that the hydrophilic monomers containing functional groups (i) and the hydrophilic monomers containing functional groups (ii) are preferably combined with one another in such a way that no insoluble salts or complexes are formed. By contrast, the hydrophilic monomers containing functional groups (i) or containing functional groups (ii) can be combined as desired with the hydrophilic monomers containing functional groups (iii).

Of the hydrophilic monomers described above, the monomers containing functional groups (i) are particularly preferably used.

The neutralisers for the functional groups (i) which can be converted into anions are preferably selected here from the group consisting of ammonia, trimethylamine, triethylamine, tributylamine, dimethylaniline, diethylaniline, triphenylamine, dimethylethanolamine, diethylethanolamine, methyldiethanolamine, 2-aminomethylpropanol, dimethylisopropylamine, dimethylisopropanolamine, triethanolamine, diethylenetriamine and triethylenetetramine, and the neutralisers for the functional groups (ii) which can be converted into cations are preferably selected here from the group consisting of sulfuric acid, hydrochloric acid, phosphoric acid, formic acid, acetic acid, lactic acid, dimethylolpropionic acid and citric acid.

The hydrophilic block is very particularly preferably selected from mono-, di- and triethylene glycol structural units.

The hydrophobic block B_{hb} follows bonded to the hydrophilic block Aₕₚ. The block B_{hb} is based on hydrophobic groups or, like the hydrophilic block, on hydrophobic monomers which are suitable for polymerisation.

Examples of suitable hydrophobic groups are straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms. Examples of such groups have already been mentioned above. In addition, aryl, polyaryl, aryl-C₁-C₆-alkyl or esters having more than 2 C atoms are suitable. The said groups may, in addition, also be substituted, in particular by halogens, where perfluorinated groups are particularly suitable.

Aryl-C₁-C₆-alkyl denotes, for example, benzyl, phenylethyl, phenylpropyl, phenylbutyl, phenylpentyl or phenylhexyl, where both the phenyl ring and also the alkylene chain may be partially or fully substituted by F as described above, particularly preferably benzyl or phenylpropyl.

Examples of suitable hydrophobic olefinically unsaturated monomers for the hydrophobic block B_{hb} are

(1) esters of olefinically unsaturated acids which are essentially free from acid groups, such as alkyl or cycloalkyl esters of (meth)acrylic acid, crotonic acid, ethacrylic acid, vinylphosphonic acid or vinylsulfonic acid having up to 20 carbon atoms in the alkyl radical, in particular methyl, ethyl, propyl, n-butyl, sec-butyl, tert-butyl, hexyl, ethylhexyl, stearyl or lauryl acrylate, methacrylate, crotonate, ethacrylate or vinylphosphonate or vinylsulfonate; cycloaliphatic esters of (meth)acrylic acid, crotonic acid, ethacrylic acid, vinylphosphonic acid or vinylsulfonic acid, in particular cyclohexyl, isobornyl, dicyclopentadienyl, octahydro-4,7-methano-1H-indenemethanol or tert-butylcyclohexyl(meth)acrylate, crotonate, ethacrylate, vinylphosphonate or vinylsulfonate. These may comprise minor amounts of polyfunctional alkyl or cycloalkyl esters of (meth)acrylic acid, crotonic acid or ethacrylic acid, such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate, trimethylolpropane tri(meth)acrylate or pentaerythritol tetra(meth)acrylate, and the analogous ethacrylates or crotonates. For the purposes of the present invention, minor amounts of polyfunctional monomers (1) are taken to mean amounts which do not result in crosslinking or gelling of the polymers;
(2) monomers which carry at least one hydroxyl group or hydroxymethylamino group per molecule and are essentially free from acid groups, such as
hydroxyalkyl esters of alpha,beta-olefinically unsaturated carboxylic acids, such as hydroxyalkyl esters of acrylic acid, methacrylic acid and ethacrylic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate or ethacrylate; 1,4-bis(hydroxymethyl)cyclohexane, octahydro-4,7-methano-1H-indenedimethanol or methylpropanediol monoacrylate, monomethacrylate, monoethacrylate or monocrotonate; or products of the reaction of cyclic esters, such as, for example, epsilon-caprolactone, and these hydroxyalkyl esters;
olefinically unsaturated alcohols, such as allyl alcohol;
allyl ethers of polyols, such as trimethylolpropane monoallyl ether or pentaerythritol mono-, di- or triallyl ether. The polyfunctional monomers are generally only used in minor amounts. For the purposes of the present invention, minor amounts of polyfunctional monomers are taken to mean amounts which do not result in crosslinking or gelling of the polymers;
products of the reaction of alpha,beta-olefinically unsaturated carboxylic acids with glycidyl esters of an alpha-branched monocarboxylic acid having 5 to 18 carbon atoms in the molecule. The reaction of acrylic or methacrylic acid with the glycidyl ester of a carboxylic acid containing a tertiary alpha-carbon atom can take place before, during or after the polymerisation reaction. The monomer (2) employed is preferably the product of the reaction of acrylic and/or methacrylic acid with the glycidyl ester of Versatic® acid. This glycidyl ester is commercially available under the name Cardura® E10. Reference is additionally made to Römpp Lexikon Lacke und Druckfarben [Römpp's Lexicon of Surface Coatings and Printing Inks], Georg Thieme Verlag, Stuttgart, New York, 1998, pages 605 and 606;
formaldehyde adducts of aminoalkyl esters of alpha,beta-olefinically unsaturated carboxylic acids and of alpha,beta-unsaturated carboxamides, such as N-methylol- and N,N-dimethylolaminoethyl acrylate, -aminoethyl methacrylate, -acrylamide and -methacrylamide; and
olefinically unsaturated monomers containing acryloxysilane groups and hydroxyl groups, which can be prepared by reaction of hydroxyl-functional silanes with epichlorohydrin 30 and subsequent reaction of the intermediate with an alpha,beta-olefinically unsaturated carboxylic acid, in particular acrylic acid or methacrylic acid, or hydroxyalkyl esters thereof;
   (3) vinyl esters of alpha-branched monocarboxylic acids having 5 to 18 carbon atoms in the molecule, such as the vinyl esters of Versatic® acid, which are marketed under the VeoVa® brand;
   (4) cyclic and/or acyclic olefins, such as ethylene, propylene, but-1-ene, pent-1-ene, hex-1-ene, cyclohexene, cyclopentene, norbornene, butadiene, isoprene, cyclopentadiene and/or dicyclopentadiene;
   (5) amides of alpha,beta-olefinically unsaturated carboxylic acids, such as (meth)acrylamide, N-methyl-, N,N-dimethyl-, N-ethyl-, N,N-diethyl-, N-propyl-, N,N-dipropyl-, N-butyl-, N,N-dibutyl- and/or N,N-cyclohexylmethyl(meth)acrylamide;
(6) monomers containing epoxide groups, such as the glycidyl esters of acrylic acid, methacrylic acid, ethacrylic acid, crotonic acid, maleic acid, fumaric acid and/or itaconic acid;
   (7) vinylaromatic hydrocarbons, such as styrene, vinyltoluene or alpha-alkylstyrenes, in particular alpha-methylstyrene;
   (8) nitrites, such as acrylonitrile or methacrylonitrile;
(9) vinyl compounds, selected from the group consisting of vinyl halides, such as vinyl chloride, vinyl fluoride, vinylidene dichloride, vinylidene difluoride; vinylamides, such as N-vinylpyrrolidone; vinyl ethers, such as ethyl vinyl ether, n-propyl vinyl ether, isopropyl vinyl ether, n-butyl vinyl ether, isobutyl vinyl ether and vinyl cyclohexyl ether; and vinyl esters, such as vinyl acetate, vinyl propionate and vinyl butyrate;
   (10) allyl compounds, selected from the group consisting of allyl ethers and esters, such as propyl allyl ether, butyl allyl ether, ethylene glycol diallyl ether, trimethylolpropane triallyl ether or allyl acetate or allyl propionate; as far as the polyfunctional monomers are concerned, that stated above applies analogously;
   (11) siloxane or polysiloxane monomers, which may be substituted by saturated, unsaturated, straight-chain or branched alkyl groups or other hydrophobic groups already mentioned above. Also suitable are polysiloxane macromonomers which have a number average molecular weight Mn of 1000 to 40,000 and contain on average 0.5 to 2.5 ethylenically unsaturated double bonds per molecule, in particular polysiloxane macromonomers which have a number average molecular weight Mn of 2000 to 20,000, particularly preferably 2500 to 10,000 and in particular 3000 to 7000, and contain on average 0.5 to 2.5, preferably 0.5 to 1.5, ethylenically unsaturated double bonds per molecule, as described in DE 38 07 571 A 1 on pages 5 to 7, DE 37 06 095 A 1 in columns 3 to 7, EP 0 358 153 B1 on pages 3 to 6, in U.S. Pat. No. 4,754,014 A 1 in columns 5 to 9, in DE 44 21 823 A 1 or in International Patent Application WO 92/22615 on page 12, line 18, to page 18, line 10; and
   (12) monomers containing carbamate or allophanate groups, such as acryloyloxy- or methacryloyloxyethyl, -propyl or -butyl carbamate or allophanate; further examples of suitable monomers which contain carbamate groups are described in the patent specifications U.S. Pat. No. 3,479,328 A 1, U.S. Pat. No. 3,674,838 A 1, U.S. Pat. No. 4,126,747 A 1, U.S. Pat. No. 4,279,833 A 1 or U.S. Pat. No. 4,340,497 A 1.

The polymerisation of the above-mentioned monomers can be carried out in any way known to the person skilled in the art, for example by polyadditions or cationic, anionic or free-radical polymerisations. Polyadditions are preferred in this connection since different types of monomer can thus be combined with one another in a simple manner, such as, for example, epoxides with dicarboxylic acids or isocyanates with diols.

The respective hydrophilic and hydrophobic blocks can in principle be combined with one another in any desired manner. The amphiphilic silanes in accordance with the present invention preferably have an HLB value in the range 2-19, preferably in the range 4-15. The HLB value is defined here as

$$H L B = \frac{mass of polar fractions}{molecular weight} \cdot 20$$

and indicates whether the silane has more hydrophilic or hydrophobic behaviour, i.e. which of the two blocks Aₕₚ and B_{hb} dominates the properties of the silane according to the invention. The HLB value is calculated theoretically and arises from the mass fractions of hydrophilic and hydrophobic groups. An HLB value of 0 indicates a lipophilic compound; a chemical compound having an HLB value of 20 has only hydrophilic fractions.

The amphiphilic silanes of the present invention are furthermore distinguished by the fact that at least one reactive functional group is bonded to Aₕₚ and/or B_{hb}. The reactive functional group is preferably located on the hydrophobic block B_{hb}, where it is particularly preferably bonded at the end of the hydrophobic block. In the preferred embodiment, the head group (R)₃Si and the reactive functional group have the greatest possible separation. This enables particularly flexible setting of the chain lengths of blocks Aₕₚ and B_{hb} without significantly restricting the possible reactivity of the reactive groups, for example with the ambient medium.

The reactive functional group can be selected from silyl groups containing hydrolytically removable radicals, OH, carboxyl, NH, SH groups, halogens and reactive groups containing double bonds, such as, for example, acrylate or vinyl groups. Suitable silyl groups containing hydrolytically removable radicals have already been described above in the description of the head group (R)₃Si. The reactive group is preferably an OH group.

Particularly preferred surface modifiers in relation to the amphiphilic silanes are, in accordance with the invention,
2-(2-hexyloxyethoxy)ethyl (3-trimethoxysilanylpropyl)carbamate, which can be prepared by reaction of isocyanatopropyltrimethoxysilane with diethylene glycol monohexyl ether,
2-(2-hexyloxyethoxy)ethyl (3-triethoxysilanylpropyl)carbamate, which can be prepared by reaction of isocyanatopropyltriethoxysilane with diethylene glycol monohexyl ether,
4-triethoxysilanyl-2-[(6-hydroxyhexylcarbamoyl)methylbutanoic acid, which can be prepared by reaction of triethoxysilylpropylsuccinic anhydride with 1-aminohexanol,
1-hexylamino-3-(3-trimethoxysilanylpropoxy)propan-2-ol, which can be prepared by reaction of glycidoxypropyltrimethoxysilane with 1-amino-hexane.

The surface modifier employed is very particularly preferably 2-(2-hexyloxyethoxy)ethyl (3-trimethoxysilanylpropyl)carbamate.

Precursors which can be employed for the nanoparticles are generally zinc salts. Preference is given to the use of zinc salts of carboxylic acids or halides, in particular zinc formate, zinc acetate or zinc propionate, as well as zinc chloride. The precursor used in accordance with the invention is very particularly preferably zinc acetate or the dihydrate thereof.

The conversion of the precursors into zinc oxide is preferably carried out in accordance with the invention in basic medium, where, in a preferred process variant, a hydroxide base, such as LiOH, NaOH or KOH, is used.

The reaction, step a), in the process according to the invention is carried out in an alcohol, where, in particular, methanol or ethanol is suitable. Methanol has proven to be a particularly suitable solvent here.

Suitable organic solvents or solvent mixtures for the dispersion of the nanoparticles according to the invention, besides the alcohols in which they are initially obtained in the process, are typical surface-coating solvents. Typical surface-coating solvents are, for example, alcohols, such as methanol or ethanol, ethers, such as diethyl ether, tetrahydrofuran and/or dioxane, esters, such as butyl acetate, or hydrocarbons, such as toluene, petroleum ether, halogenated hydrocarbons, such as dichloromethane, or also commercially available products, such as solvent naphtha or products based on Shellsol, a high-boiling hydrocarbon solvent, for example Shellsol A, Shellsol T, Shellsol D40 or Shellsol D70.

The particles according to the invention preferably have an average particle size, determined by particle correlation spectroscopy (PCS), as described above, or transmission electron microscope, of 5 to 20 nm, preferably 7 to 15 nm. In specific, likewise preferred embodiments of the present invention, the distribution of the particle sizes is narrow, i.e. the d50 value, and in particularly preferred embodiments even the d90 value, is preferably in the above-mentioned ranges from 5 to 15 nm, or even from 7 to 12 nm.

In the sense of the use of these nanoparticles for UV protection in polymers, it is particularly preferred if the absorption edge of a dispersion is located with, for example, 0.001% by weight of the nanoparticles in the range 300-400 nm, preferably in the range up to 330-380 nm and particularly preferably in the range 355 to 365 nm. It is furthermore particularly preferred in accordance with the invention if the transmission of this dispersion (or also synonymously used suspension) with a layer thickness of 10 mm, comprising 0.001% by weight, where the % by weight data is limited by the investigation method, is less than 10%, preferably less than 5%, at 320 nm and greater than 90%, preferably greater than 95% at 440 nm.

The measurement is carried out in a UV/VIS spectrometer (Varian Carry 50). The concentration of the solution here is matched to the instrument sensitivity (dilution to about 0.001% by weight).

The process according to the invention can be carried out as described above. The reaction temperature here can be selected in the range between room temperature and the boiling point of the solvent selected. The reaction rate can be controlled through a suitable choice of the reaction temperature, the starting materials and the concentration thereof and the solvent, so that the person skilled in the art is presented with absolutely no difficulties in controlling the rate in such a way that monitoring of the course of the reaction by UV spectroscopy is possible.

In certain cases, it may be helpful if an emulsifier, preferably a nonionic surfactant, is employed. Preferred emulsifiers are optionally ethoxylated or propoxylated, relatively long-chain alkanols or alkylphenols having various degrees of ethoxylation or propoxylation (for example adducts with 0 to 50 mol of alkylene oxide).

Dispersion aids can also advantageously be employed, preference being given to the use of water-soluble, high-molecular-weight organic compounds containing polar groups, such as polyvinylpyrrolidone, copolymers of vinyl propionate or acetate and vinylpyrrolidone, partially saponified copolymers of an acrylate and acrylonitrile, polyvinyl alcohols having various residual acetate contents, cellulose ethers, gelatine, block copolymers, modified starch, low-molecular-weight polymers containing carboxyl and/or sulfonyl groups, or mixtures of these substances.

Particularly preferred protective colloids are polyvinyl alcohols having a residual acetate content of less than 40 mol %, in particular 5 to 39 mol %, and/or vinylpyrrolidone-vinyl propionate copolymers having a vinyl ester content of less than 35% by weight, in particular 5 to 30% by weight.

Adjustment of the reaction conditions, such as temperature, pressure, reaction duration, enables the desired property combinations of the requisite nanoparticles to be set in a targeted manner. The corresponding adjustment of these parameters presents the person skilled in the art with absolutely no difficulties. For example, the reaction can for many purposes be carried out at atmospheric pressure and in the temperature range between 30 and 50° C.

The nanoparticles according to the invention, dispersed in an organic solvent or isolated, are used, in particular, for UV protection in polymers. In this application, the particles either protect the polymers themselves against degradation by UV radiation, or the polymer composition comprising the nanoparticles is in turn employed—for example in the form of a protective film or applied as a coating film—as UV protection for other materials. The present invention therefore furthermore relates to the corresponding use of nanoparticles according to the invention for the UV stabilisation of polymers and UV-stabilised polymer compositions essentially consisting of at least one polymer or a surface-coating composition, which is characterised in that the polymer comprises nanoparticles according to the invention. Polymers into which the isolated nanoparticles according to the invention can be incorporated well are, in particular, polycarbonate (PC), polyethylene terephthalate (PETP), polyimide (PI), polystyrene (PS), polymethyl methacrylate (PMMA) or copolymers comprising at least a proportion of one of the said polymers.

The incorporation can be carried out here by conventional methods for the preparation of polymer compositions. For example, the polymer material can be mixed with isolated nanoparticles according to the invention, preferably in an extruder or compounder.

A particular advantage of the particles according to the invention with a silane coating consists in that only a low energy input compared with the prior art is necessary for homogeneous distribution of the particles in the polymer.

The polymers here can also be dispersions of polymers, such as, for example, surface coatings or surface-coating compositions. The incorporation can be carried out here by conventional mixing operations. The good redispersibility of the particles according to the invention, as described in step c) or d), will simplify in particular the preparation of dispersions of this type, Correspondingly, the present invention furthermore relates to dispersions of the particles according to the invention comprising at least one polymer.

The polymer compositions according to the invention comprising the isolated nanoparticles or the dispersions according to the invention are furthermore also suitable, in particular, for the coating of surfaces, for example of wood, plastics, fibres or glass. The surface or the material lying under the coating can thus be protected, for example, against UV radiation.

The following examples serve to illustrate the invention without limiting it. The invention can be carried out correspondingly throughout the range indicated in this description.

### EXAMPLES

### Example 1

### Formation of ZnO Particles

42.5 ml of a methanolic KOH solution (5 mol/l) are added to 500 ml of a methanolic Zn(AcO)₂.2H₂O solution (0.25 mol/l) at 50° C.

The conversion into zinc oxide and the growth of the nanoparticles can be monitored by UV spectroscopy. After a reaction duration of only one minute, the absorption maximum remains constant, i.e. the ZnO formation is already complete in the first minute. The absorption edge shifts to longer wavelengths with increasing reaction duration. This can be correlated with continuing growth of the ZnO particles due to Ostwald ripening.

### Example 2

### Modification by Addition of TMOS

After 30 min, when the absorption edge has reached the value 360 nm, 30 ml of tetramethyl orthosilicate (TMOS) are added, and stirring is continued at 50° C.

After the addition, no further shift of the absorption edge is observed. The suspension remains stable and transparent over several days.

The potassium acetate formed in the reaction is separated off by ultrafiltration, giving a stable, transparent suspension which, according to UV spectroscopy and X-ray diffraction, comprises ZnO. The diameter of the particles, according to particle correlation spectroscopic investigation using a Malvern Zetasizer (PCS), is 4-12 nm with a d50 of 6-7 nm and a d90 of 5-10 nm. Furthermore, no potassium acetate reflections are visible in the X-ray diagram.

### Example 2C

A comparative experiment without addition of the TMOS solution shows continued particle growth and becomes cloudy after 14 h.

### Example 3

### Modification by Subsequent Silanisation

### Example 3a

### Preparation of an Amphiphilic Silane

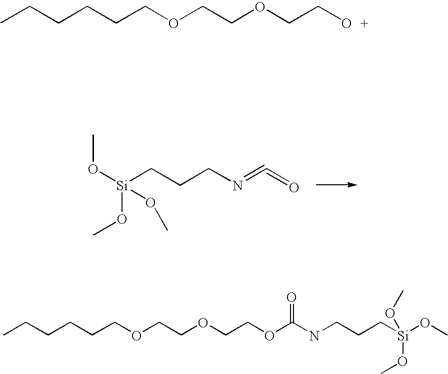

Under protective gas, equimolar amounts of isocyanatopropyltrimethoxysilane and diethylene glycol monohexyl ether are combined in toluene in a nitrogen round-bottomed flask and stirred overnight at 90° C. on a reflux condenser. Reaction monitoring by means of thin-layer chromatography (toluene:ethyl acetate 1:1) shows virtually complete reaction. All volatile constituents are removed on a rotary evaporator, giving a colourless liquid, which is employed without further purification.

### Example 3b

### Silanisation

20 ml of the amphiphilic silane prepared in Example 3a are added to the product dispersion from Example 2 at 50° C., and the mixture is stirred at 50° C. for a further 18 h, giving a stable, transparent suspension which, according to UV spectroscopy and X-ray diffraction, comprises ZnO. The diameter of the particles, according to particle correlation spectroscopic investigation using a Malvern Zetasizer (PCS), is 4-12 nm with a d50 of 6-7 nm and a d90 of 5-10 nm.

Re-measurement after 10 days gave the same values within the boundaries of measurement accuracy. Agglomeration of the particles can thus be excluded. Furthermore, no potassium acetate reflections are visible in the X-ray diagram.

### Example 3C

Without silanisation, the ultracentrifuged suspension from Ex. 2 becomes cloudy after 2 days. The particles precipitate within one week. This can be monitored by UV spectrometric investigation of the supernatant solution. A constant decrease in the UV absorption is observed.

### Example 4

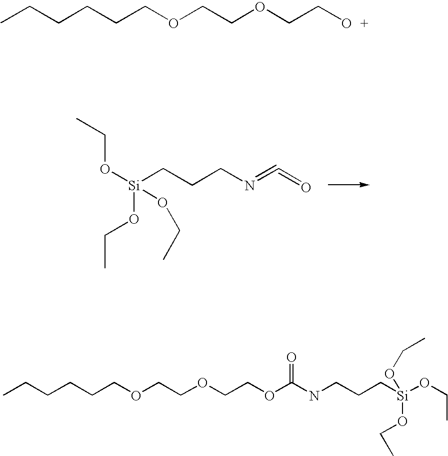

Under protective gas, equimolar amounts of isocyanatopropyltriethoxysilane and diethylene glycol monohexyl ether are combined in toluene in a nitrogen round-bottomed flask and stirred overnight at 90° C. on a reflux condenser. Reaction monitoring by means of thin-layer chromatography (toluene:ethyl acetate 1:1) shows virtually complete reaction. All volatile constituents are removed on a rotary evaporator, giving a colourless liquid, which is employed without further purification.

The subsequent silanisation is carried out analogously to Example 3b.

### Example 5

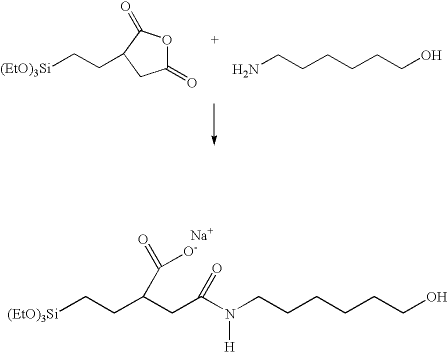

50 g of THF, 30.4 g of Geniosil GF 20 (triethoxysilylpropylsuccinic anhydride, Wacker, Germany) and 11.7 g of 1-aminohexanol are mixed and refluxed for one hour with stirring. The tetrahydrofuran is subsequently removed by distillation.

The subsequent silanisation is carried out analogously to Example 3b.

### Example 6

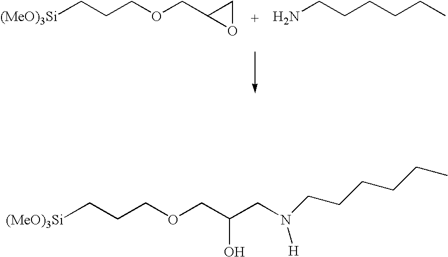

23.6 g of glycidoxypropyltrimethoxysilane are added dropwise with stirring to a solution of 10.1 g of 1-aminohexane in 50 g of tetrahydrofuran and subsequently refluxed for one hour. The tetrahydrofuran is subsequently removed by distillation.

The subsequent silanisation is carried out analogously to Example 3b.

### Example 7

### Conversion in Butyl Acetate

500 ml of butyl acetate are added to the suspensions of the silanised particles from Example 3 or 4, and the methanol is removed by distillation, giving transparent suspensions of zinc oxide in butyl acetate having an average particle size (PCS) of 4-12 nm.

### Example 8

### Conversion in Solvent Naphtha

500 ml of solvent naphtha are added to the suspensions of the silanised particles from Example 6, and the methanol is removed by distillation, giving transparent suspensions of zinc oxide in solvent naphtha having an average particle size (PCS) of 4-12 nm.

### Example 9

### Preparation of a Polymer Nanocomposite

The suspension from Example 5 is evaporated to dryness under reduced pressure, giving a fine, free-flowing powder comprising surface-modified zinc oxide.

10 g of these particles are mixed with 1 kg of PMMA (polymethyl methacrylate, PPMA moulding material 7H from Degussa Röhm) in an extruder, and 10 g of the resultant granules are re-extruded with 100 g of the same polymer. The resultant nanocomposite is converted into plates with a thickness of 1.5 mm by injection moulding, These plates are transparent and exhibit <5% transmission at 350 nm and >90% transmission at 450 nm, measured in a UV/VIS spectrometer.

1. Zinc oxide nanoparticles having an average particle size, determined by particle correlation spectroscopy (PCS), in the range from 3 to 50 nm, whose particle surface has been modified by means of silica, dispersed in an organic solvent, characterised in that they are obtainable by a process in which in a step a) one or more precursors of the nanoparticles are converted into the nanoparticles in an alcohol, in a step b) the growth of the nanoparticles is terminated by addition of at least one modifier, which is a precursor of silica, when the absorption edge in the UV/VIS spectrum of the reaction solution has reached the desired value, and optionally in step c) the alcohol from step a) is removed and replaced by another organic solvent.

2. Nanoparticles according to claim 1, characterised in that the zinc oxide particles have an average particle size, determined by particle correlation spectroscopy (PCS), of 5 to 20 nm, preferably 7 to 15 nm.

3. Nanoparticles according to claim 1, characterised in that the modifier is a trialkoxysilane or a tetraalkoxysilane, where alkoxy preferably stands for methoxy or ethoxy, particularly preferably for methoxy.

4. Nanoparticles according to claim 1, characterised in that the silica coating has been modified by means of at least one further surface modifier selected from the group consisting of organofunctional silanes, quaternary ammonium compounds, phosphonates, phosphonium and sulfonium compounds or mixtures thereof, preferably an organofunctional silane.

5. Nanoparticles according to claim 4, characterised in that the silane is an amphiphilic silane of the general formula (R)₃Si—S_{P}-Aₕₚ-B_{hb}, where the radicals R may be identical or different and represent hydrolytically removable radicals, S_{P} denotes either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms, Aₕₚ denotes a hydrophilic block, B_{hb} denotes a hydrophobic block, and where at least one reactive functional group is preferably bonded to Aₕₚ and/or B_{hb}.

6. Nanoparticles according to claim 4, characterised in that the amphiphilic silane is selected from the group 2-(2-hexyloxyethoxy)ethyl (3-trimethoxysilanylpropyl)carbamate, 2-(2-hexyloxyethoxy)ethyl (3-triethoxysilanylpropyl)carbamate, 4-triethoxysilanyl-2-[(6-hydroxyhexylcarbamoyl)methylbutanoic acid and 1-hexylamino-3-(3-trimethoxysilanylpropoxy)propan-2-ol.

7. Dispersion comprising nanoparticles according to claim 1 and a polymer.

8. Dispersion according to claim 7, characterised in that the dispersion is a surface coating or a surface-coating composition.

9. Process for the production of zinc oxide nanoparticles having an average particle size in the range from 3 to 50 nm, dispersed in an organic solvent, according to claim 1, characterised in that in a step a) one or more precursors of the nanoparticles are converted into the nanoparticles in an alcohol, in a step b) the growth of the nanoparticles is terminated by addition of at least one modifier, which is a precursor of silica, when the absorption edge in the UV/VIS spectrum of the reaction solution has reached the desired value, optionally in a step c) the silica coating is modified by addition of at least one further surface modifier selected from the group consisting of organofunctional silanes, quaternary ammonium compounds, phosphonates, phosphonium and sulfonium compounds or mixtures thereof, and optionally, in step d), the alcohol from step a) is removed and replaced by another organic solvent.

10. Process according to claim 9, characterised in that the precursors of the zinc oxide are selected from the zinc salts of carboxylic acids or halides, preferably from zinc formate, zinc acetate, zinc propionate and zinc chloride, where zinc acetate is particularly preferred.

11. Process according to claim 9, characterised in that the conversion of the precursors is carried out by addition of base.

12. Process according to claim 9, characterised in that the modifier is a trialkoxysilane or a tetraalkoxysilane, where alkoxy preferably stands for methoxy or ethoxy, particularly preferably for methoxy.

13. Process according to claim 9, characterised in that the absorption edge is in the range 300-400 nm, preferably in the range up to 330-380 nm and particularly preferably in the range 355 to 365 nm.

14. Process according to claim 9, characterised in that the surface modifier is an amphiphilic silane of the general formula (R)₃Si—S_{P}-Aₕₚ-B_{hb}, where the radicals R may be identical or different and represent hydrolytically removable radicals, S_{P} denotes either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms, Aₕₚ denotes a hydrophilic block, B_{hb} denotes a hydrophobic block, and where at least one reactive functional group is preferably bonded to Aₕₚ and/or B_{hb}.

15. Process according to claim 9, characterised in that the organic solvent is selected from alcohols, ethers, esters and hydrocarbons.

16. Process according to claim 9, characterised in that an emulsifier, preferably a nonionic surfactant, is employed.

17. Zinc oxide nanoparticles having an average particle size, determined by particle correlation spectroscopy (PCS), in the range from 3 to 50 nm, characterised in that they are obtainable by a process according to claim 9, but where, in step d), the alcohol from step a) is removed to dryness.

18. Process for the production of zinc oxide nanoparticles having an average particle size, determined by particle correlation spectroscopy (PCS), in the range from 3 to 50 nm, characterised in that they are produced by a process according to claim 9, but where, in step d), the alcohol from step a) is removed to dryness.

19. A method for the UV stabilisation of polymers comprising using nanoparticles of claim 1 or a dispersion thereof.

20. Polymer composition essentially consisting of at least one polymer, characterised in that the polymer comprises nanoparticles according to claim 17.

21. Polymer composition according to claim 20, characterised in that the polymer is polycarbonate, polyethylene terephthalate, polyimide, polystyrene, polymethyl methacrylate or a copolymers comprising at least a proportion of one of the said polymers.

22. Process for the preparation of polymer compositions according to claim 20, characterised in that the polymer material is mixed with zinc oxide nanoparticles having an average particle size, determined by particle correlation spectroscopy (PCS), in the range from 3 to 50 nm, preferably in an extruder or a compounder.

23. Wood treated with a dispersion according to claim 7.

24. Plastic treated with a dispersion according to claim 7 comprising a polymer composition comprising zinc oxide nanoparticles having an average particle size, determined by particle correlation spectroscopy (PCS), in the range from 3 to 50 nm.

25. Fibre treated with a dispersion according to claim 7 or comprising a polymer composition comprising zinc oxide nanoparticles having an average particle size, determined by particle correlation spectroscopy (PCS), in the range from 3 to 50 nm.

26. Glass treated with a dispersion according to claim 7.
